(19) United States
(12) Patent Application Publication
(10) Pub. No.: US 2011/0139732 A1
(43) Pub. Date: Jun. 16, 2011

(54) Refrigerator placemat holder

(76) Inventor: Reynaldo CABANBAN, Miramar, FL (US)

(21) Appl. No.: 12/749,382

(22) Filed: Mar. 29, 2010

Related U.S. Application Data
(60) Provisional application No. 61/285,545, filed on Dec. 11, 2009.
(60) Provisional application No. 61/299,024, filed on Jan. 28, 2010.

(51) Int. Cl. A47G 29/00; F16M 13/02; F16B 47/00

(52) U.S. Cl. 211/13.1; 248/206.5; 248/206.2

(57) ABSTRACT

A placemat holder that allows a user to house placemats within the body of the structure. The placemat holder attaches to the front or side of a refrigerator.

### CROSS REFERENCE TO RELATED APPLICATIONS

This application claims the benefit of U.S. provisional application Ser. No. 61/285,545 filed on Dec. 11, 2009 and U.S. provisional application Ser. No, 61/299,024 filed on Jan. 28, 2010.

### FIELD OF THE INVENTION

The present invention relates generally to a device used to store articles. More specifically, the present invention relates to a placemat holder that allows convenient storage of placemats on the front or side of a refrigerator when the placemats are not in use. The placemat holder is held in place either by one or more magnetic strips or a number of suction cups.

### DESCRIPTION OF RELATED ART

Magnetic item holders attachable to refrigerators have been devised to hold a multitude of items. Known prior art includes U.S. Pat. No. 5,941,623 (Terrance Linehan, Aug. 24, 1999), U.S. Pat. No. 6,318,569 (Reginald Rothing, Nov. 20, 2001), U.S. Pat. No. 5,351,813 (Bruce Golovan, Oct. 4, 1994), U.S. Pat. No. 6,364,126 (Robert Enriquez, Apr. 2, 2002), U.S. Pat. No. 4,736,853 (Kevin O'Mara, Apr. 12, 1998), U.S. Pat. No. 4,100,684 (Stuart Berger, Jul. 18, 1978), U.S. Pat. No. 5,947,304 (Kelly Thorp, Sep. 7, 1999), U.S. Design Pat. No. D301101 (Stephen Meyer, May 16, 1989), U.S. Design Pat. No. D308148 (Stephen Meyer, May 29, 1990), U.S. Design Pat. No. D289122 (Stephen Meyer, Apr. 7, 1987). Although the prior art fulfill their respective objectives, at the present time there is no placemat holder that stores placemats vertically on either the front or the side of a refrigerator.

Placemats are usually stored in kitchen or dining room drawers or closets. Some people usually wash or wipe placemats with a damp cloth. Putting away a wet or damp placemat in a drawer or a closet is undesirable, for mold might form on either the placemats or in the storage areas. Therefore, placemats are sometimes left to dry on tables or counter tops before being placed in drawers or closets.

Today, some kitchens and dining rooms have limited storage places. In these small kitchens or dining rooms, users require additional space where they can store their placemats. The present invention offers a convenient placemat storage solution that will maximize the capacity of storage space in a kitchen. In addition, it will allow a user to have easier and quicker access to the placemats. Furthermore, it will allow placemats to be dried in an open environment, thereby allowing the placemats to dry faster.

### SUMMARY

In accordance with the present invention, a placemat holder is proposed which is made of a lightweight and durable polymer or metal, shaped in such a way that will effectively hold a plurality of placemats vertically along the front or side of a refrigerator. The present invention includes one or more magnetic strips permanently attached to its back, which are naturally attracted to the metallic surface of the refrigerator. Keyholes are also found in strategic locations in the back of the present invention to accommodate suction cups so that it can be used on refrigerators with non-magnetic surfaces.

An object of the present invention is to maximize the amount of storage space within a kitchen.

Another object of the present invention is to provide a placemat holder that will allow placemats to be dried in an open space.

A further object of the present invention is to allow users to have easier access to placemats.

### DRAWINGS

These and other features, aspects, and advantages of the present invention will become better understood with regard to the following description, appended claims, and drawings where:

FIG. 1 is a front perspective view of a first embodiment a refrigerator placemat holder of the present invention;

FIG. 2 is a cross sectional view of the refrigerator placemat holder shown in FIG. 1;

FIG. 3 is a back perspective view of the refrigerator placemat holder shown in FIG. 1;

FIG. 4 is a front perspective view of the refrigerator placemat holder shown in FIG. 1 mounted onto the front of a refrigerator, with placemats inserted;

FIG. 5 is a front perspective view of a second embodiment of the refrigerator placemat holder of the present invention;

FIG. 6 is a back perspective view of the refrigerator placemat holder shown in FIG. 5;

FIG. 7 is a front perspective view of a third embodiment of the refrigerator placemat holder of the present invention, this embodiment is for housing round or oblong shaped placemats;

FIG. 8 is a back perspective view of the refrigerator placemat holder in FIG. 7;

FIG. 9 is a front perspective view of a fourth embodiment of the refrigerator placemat holder of the present invention, this embodiment is for housing fabric placemats;

FIG. 10 is a back perspective view of the refrigerator placemat holder in FIG. 9; and

FIG. 11 is a front perspective view of the refrigerator placemat holder in FIG. 9 showing fabric placemats housed within the placemat holder.

### DETAILED DESCRIPTION OF THE INVENTION

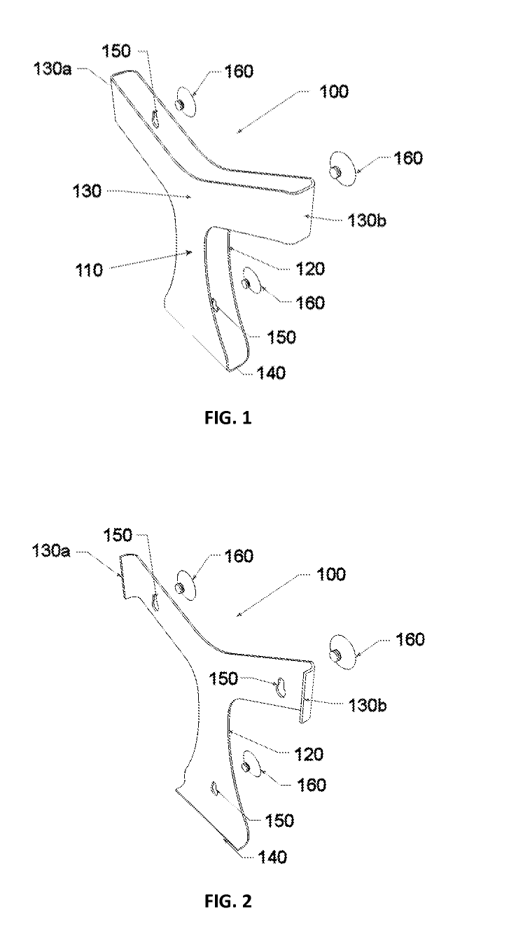

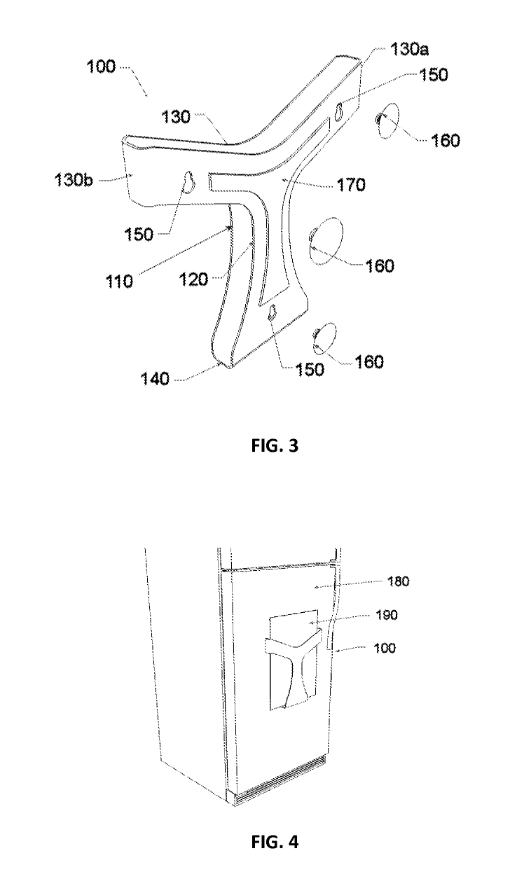

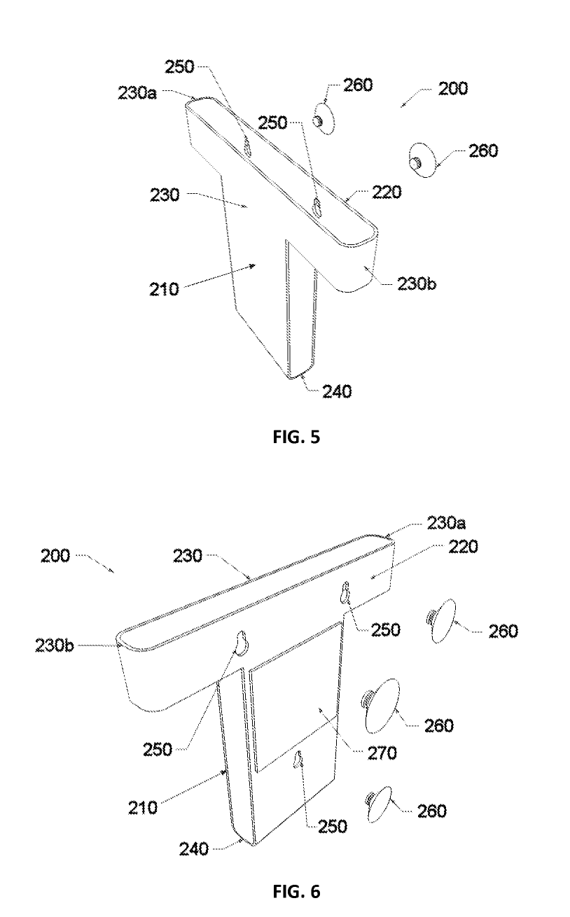

As shown in FIGS. 1-6, in a first and second embodiment of the present invention, a placemat holder 100/200 comprises of a structure 100/200 having a front 110/210, rear 120/220, bottom 140/240 and top side 130/230, wherein the bottom side 140/240 is perpendicular to the front 110/210 and rear 120/220 sides, and the front 110/210 and rear 120/220 sides are parallel to each other and are shaped so that they run vertically upward from the bottom side 140/240 up to a point wherein they split horizontally outward at the top side 130/230, the top side 130/230 has a left 130a/230a and a right 130b/230b side that are opposed to each other and that are perpendicular to the front 110/210 and rear 120/220 sides, all of the sides define openings except wherein the walls are perpendicular to each other. The first 100 and second 200 embodiments of the present invention further comprise of a means for attaching the placemat holder to a refrigerator 170/270 or (150&160/250&260), the means 170/270 or (150&160/250&260) being on the rear side 120/220 of the placemat holder 100/200. In an embodiment, the means is a magnet 170/2′70. In another embodiment, the rear side of the placemat holder 120/220 would define at least one eyelet 150/250 wherein at least one suction cup 160/260 would be inserted. The first two embodiments of the present invention are designed to house sturdy rectangular placemats.

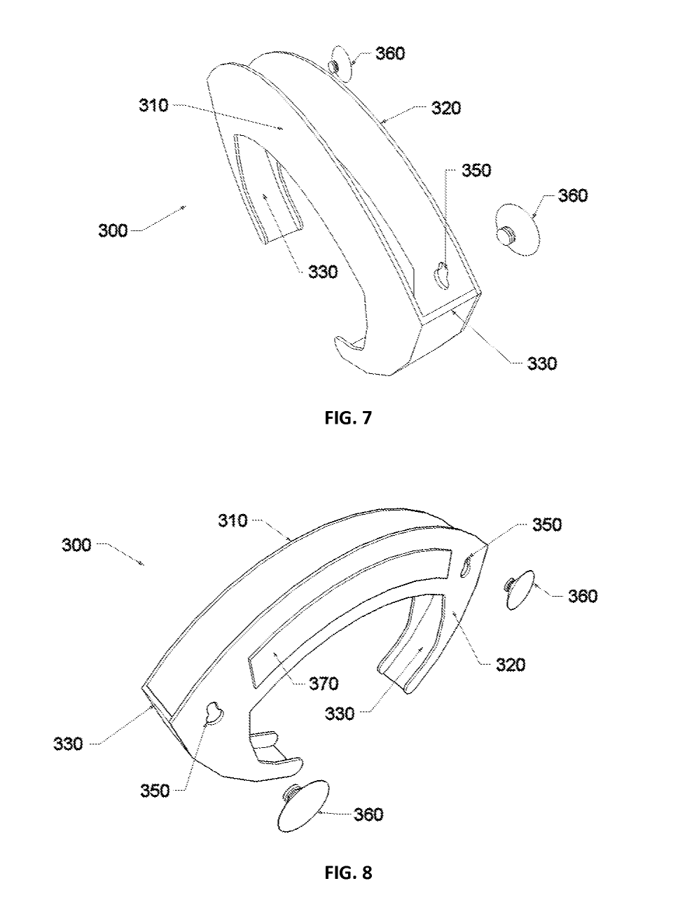

As shown in FIGS. 7-8, in a third embodiment of the present invention, the placemat holder 300 comprises of a c-shaped structure 300, wherein the c-shaped structure 300 has a front 310, a rear 320, and two parallel 330 sides, the parallel sides 330 separate the front 310 and rear 320 sides of the c-shaped structure 300 so that c-shaped structure 300 defines openings on the top and the bottom of the structure 300. The third embodiment 300 of the present invention further comprise of a means for a attaching the placemat holder to a refrigerator 370 or (350/360), the means 370 or (350&360) being on the rear side 320 of the placemat holder 300. In an embodiment, the means is a magnet 370. In another embodiment, the rear side of the placemat holder 320 would define at least one eyelet 350 wherein at least one suction cup 360 would be inserted. The C-shaped embodiment 300 is used to house round or oblong shaped placemats.

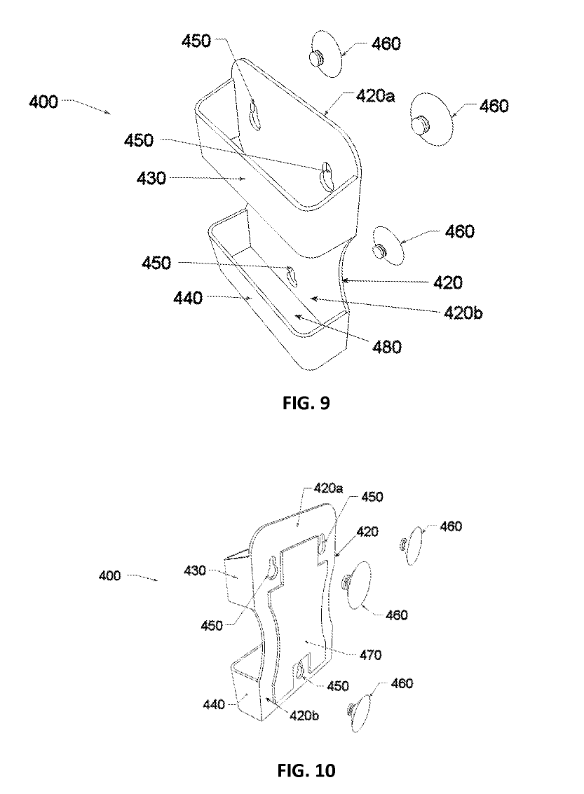

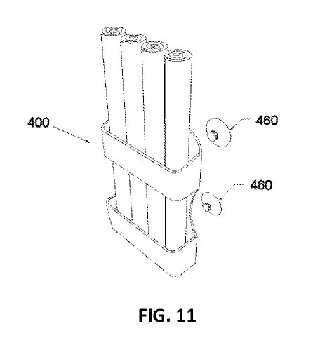

As shown in FIGS. 9-11, in a fourth embodiment of the present invention, the placemat holder 400 comprises of structure 400 having a first 420, a second 430 and a third piece 440, the first piece 420 is a substantially planar structure having a top 420a and a bottom 420b, the second piece 430 is a u-shaped piece 430 that is attached at a position adjacent to the top 420a of the first piece 420 so that the u-shaped piece 430 forms a channel within the first piece 420 and the second piece 430, the third piece 440 is a u-shaped cradle 440 that attaches to the bottom 420b of the first piece 420 so that the third piece 440 and the first piece 420 form a cradle 480 wherein flexible storage mats can be housed. The fourth embodiment 400 of the present invention further comprise of a means for attaching the placemat holder to a refrigerator 470 or (450&460), the means 470 or (450&460) being on the rear side 420 of the placemat holder 400. In an embodiment, the means is a magnet 470. In another embodiment, the rear side of the placemat holder 420 would define at least one eyelet 450 wherein at least one suction cup 460 would be inserted.

An advantage of the present invention is that it maximizes the amount of storage space within a kitchen.

Another advantage of the present invention is that it provides a placemat holder that allows placemats to be dried in an open space.

A further advantage of the present invention is that it allows users to have easier access to placemats.

Although the present invention has been described in considerable detail with reference to certain preferred versions thereof, other versions are possible. Therefore the spirit and the scope of the claims should not be limited to the description of the preferred versions contained herein.

What is claimed is:

1. A placemat holder for housing placements that is disposed on a refrigerator, the placemat holder comprises:
a structure having a front, rear, bottom and top side, wherein the bottom side is perpendicular to the front and rear sides, and the front and rear sides are parallel to each other and are shaped so that they run vertically upward from the bottom side up to a point wherein they split horizontally outward at the top side, the top side has a left and a right side that are opposed to each other and that are perpendicular to the front and rear sides, all of the sides define openings except wherein the walls are perpendicular to each other; and
a means for attaching the placemat holder to a refrigerator, the means being on the rear side of the placemat holder.

2. The placemat holder of claim 1, wherein the means is a magnet.

3. The placemat holder of claim 1, wherein the rear side of the placemat holder defines at least one eyelet wherein the means is at least one suction cup that is inserted within the eyelet.

4. A placemat holder for housing placements that is disposed on a refrigerator, the placemat holder comprises:
a c-shaped structure, wherein the c-shaped structure has a front, a rear, and two parallel sides, the parallel sides separate the front and rear sides of the c-shaped structure so that c-shaped structure defines openings on the top and the bottom of the structure; and
a means for attaching the placemat holder to a refrigerator, the means being on the rear side of the placemat holder.

5. The placemat holder of claim 4, wherein the means is a magnet.

6. The placemat holder of claim 4, wherein the rear side of the placemat holder defines at least one eyelet wherein the means is at least one suction cup that is inserted within the eyelet.

7. A placemat holder for housing placements that is disposed on a refrigerator, the placemat holder comprises:
A structure having a first, a second and a third piece, the first piece is a substantially planar structure having a top and a bottom, the second piece is a u-shaped piece that is attached at a position adjacent to the top of the first piece so that the u-shaped piece forms a channel within the first piece and the second piece, the third piece is a u-shaped cradle that attaches to the bottom of the first piece so that the third piece and the first piece form a cradle wherein flexible storage mats can be housed; and
a means for attaching the placemat holder to a refrigerator, the means being on the rear side of the placemat holder.

8. The placemat holder of claim 7, wherein the means is a magnet.

9. The placemat holder of claim 7, wherein the rear side of the placemat holder defines at least one eyelet wherein the means is at least one suction cup that is inserted within the eyelet.
